(19) United States
(12) Patent Application Publication
(10) Pub. No.: US 2008/0101177 A1
(43) Pub. Date: May 1, 2008

(54) Optical disc recording apparatus and optical disc recording method

(75) Inventor: Syunsuke Sehara, Osaka (JP)

Correspondence Address: MORGAN LEWIS & BOCKIUS LLP, 1111 PENNSYLVANIA AVENUE NW, WASHINGTON, DC, 20004, US

(73) Assignee: Funai Electric Co., Ltd., Osaka (JP)

(21) Appl. No.: 11/907,899

(22) Filed: Oct. 18, 2007

(30) Foreign Application Priority Data
Oct. 25, 2006 (JP) 2006-289498

(51) Int. Cl. G11B 19/02

(52) U.S. Cl. 369/47.5

(57) ABSTRACT

Prior to recording operation of an optical disc, OPC is performed three times so as to obtain optimal recording powers. By averaging the obtained optimal recording powers, an optimal recording power that is used for recording operation is obtained. More specifically, recording operation is performed continuously with respect to three continuous regions (16-18) each of which includes 10 sectors, and then reading operation is performed continuously with respect to the three regions (16-18). Then, by averaging results obtained from the three regions (16-18), an optimal recording power is obtained, which is adapted to characteristics of the disc.

This application is based on Japanese Patent Application No. 2006-289498 filed on Oct. 25, 2006, the contents of which are hereby incorporated by reference.

### BACKGROUND OF THE INVENTION

1. Field of the Invention

The present invention relates to an optical disc recording apparatus such as a DVD recorder and an optical disc recording method that is used in the optical disc recording apparatus.

2. Description of Related Art

The optical disc recording apparatus such as a DVD recorder performs optimum power control (hereinafter referred to as OPC) for determining a recording power before recording data on a disc, where the OPC means optimizing of the recording power of an optical pickup. The OPC is performed for reducing influence of wobbling or warp of a disc, or characteristics or unevenness of a recording layer. When this OPC is performed, an optimal recording power is selected for each disc so that high quality recording can be performed on the entire disc.

Before describing about the OPC concretely, a structure of a disc will be described with reference to FIG. 1. FIG. 1 is a schematic diagram of an optical disc. The optical disc 1 has a spindle hole 2 formed at the center of the disc for rotating the disc, and the outside of the spindle hole 2 is a recording region 3.

The OPC includes a plurality of test recording steps that are performed with changing the recording power in stages with respect to a power calibration area (hereinafter referred to as PCA) 4 in the recording region 3 at the vicinity of the spindle hole 2. Then, each data recorded by the test recording is read so as to obtain a signal, and an asymmetry value (hereinafter referred to as β value) that is a value indicating asymmetry of the signal is calculated based on a peak value and a bottom value of the obtained signal, for each recording power. Then, the recording power when the β value becomes an appropriate value is determined by checking correlation between the β value and the recording power, so that the recording power that is used for actual recording is decided. Note that the asymmetry of the signal indicated by the β value is caused from a size and a pitch of pits formed on the disc by the recording action. A good symmetry of the signal indicates that appropriate pits are formed with the optimal recording power.

In a conventional method of performing the OPC for an optical disc such as a CD or a DVD, the recording power is changed in fifteen stages. In particular, one ECC block, i.e., sixteen sectors are used as a unit of recording in the case of DVD. In this method, a first sector is used for testing whether or not a laser diode operate correctly, and remaining fifteen sectors are used for recording and reading test data with changing the cording power in fifteen stages.

However, if the OPC is performed only in fifteen sectors with fifteen different stages of recording powers, disturbance factors due to wobbling or warp may affect strongly so that too strong or too weak recording power may be selected in a certain situation of the disc. Then, recording quality may be deteriorated, so that recording or reproducing may not be performed correctly.

### SUMMARY OF THE INVENTION

An object of the present invention is to provide an optical disc recording apparatus and an optical disc recording method that can select an appropriate recording power for characteristics of a disc accurately.

An optical disc according to an embodiment of the recording apparatus of the present invention performs a recording power optimizing operation before recording data on an optical disc, in which data is recorded as a test with a plurality of recording powers having different levels, and an optimal recording power is decided based on a signal read from the data recorded as the test. The data recording as the test in the recording power optimizing operation is performed continuously with respect to three continuous regions on the optical disc, reading of the data recorded as the test is performed continuously with respect to the three continuous regions, and the optimal recording power is decided by averaging three first optimal recording powers obtained from the read signals.

An optical disc according to another embodiment of the recording apparatus of the present invention further performs a recording power optimizing operation before recording data on an optical disc, in which data is recorded as a test with a plurality of recording powers having different levels, and an optimal recording power is decided based on a signal read from the data recorded as the test. The data recording as the test in the recording power optimizing operation is performed continuously with respect to three continuous regions on the optical disc, and reading of the data recorded as the test is performed continuously with respect to the three continuous regions, and the optimal recording power is decided based on a signal obtained by averaging read signals.

In addition, an optical disc recording method according to an embodiment of the present invention performs a recording power optimizing operation before recording data on an optical disc, the method includes the steps of recording data as a test with a plurality of recording powers having different levels, and deciding an optimal recording power based on a signal read from the data recorded as the test. The data recording as the test in the recording power optimizing operation is performed continuously with respect to three continuous regions on the optical disc, reading of the data recorded as the test is performed continuously with respect to the three continuous regions, and the optimal recording power is decided by averaging three first optimal recording powers obtained from the read signals.

In addition, an optical disc recording method according to another embodiment of the present invention performs a recording power optimizing operation before recording data on an optical disc, the method includes the steps of recording data as a test with a plurality of recording powers having different levels, and deciding an optimal recording power based on a signal read from the data recorded as the test. The data recording as the test in the recording power optimizing operation is performed continuously with respect to three continuous regions on the optical disc, reading of the data recorded as the test is performed continuously with respect to the three continuous regions, and the optimal recording power is decided based on a signal obtained by averaging read signals.

According to the structure of the present invention, three times of OPCs can be performed in the PCA regions. Then, by averaging the optimal recording powers obtained from the OPCs, influence of disturbance can be reduced so that a recording power adapted to characteristics of the disc can be selected. In addition, it is possible to average signals obtained from the OPCs and to decide the optimal recording power based on the averaged signal so that influence of disturbance can be reduced and a recording power adapted to characteristics of the disc can be selected.

### BRIEF DESCRIPTION OF THE DRAWINGS

FIG. 1 is a schematic diagram of an optical disc.

FIG. 2 is a block diagram showing a structure of an optical disc recording apparatus according to an embodiment of the present invention.

FIG. 3 is a flowchart showing a general outline of a recording operation of the optical disc recording apparatus according to the embodiment of the present invention.

FIG. 4 is an enlarged schematic diagram of a PCA of an optical disc corresponding to an OPC of the optical disc recording apparatus according to the embodiment of the present invention.

FIG. 5 is a flowchart of a rough OPC of the optical disc recording apparatus according to the embodiment of the present invention.

FIG. 6 is a graph showing recording powers that are used for the rough OPC of each sector that is used for recording in the optical disc recording apparatus according to the embodiment of the present invention.

FIG. 7 is a graph showing correlation between the β value and the recording power that is obtained by the rough OPC of the optical disc recording apparatus according to the embodiment of the present invention.

FIG. 8 is a flowchart of a real OPC of the optical disc recording apparatus according to the embodiment of the present invention.

FIG. 9 is a graph showing recording powers that are used for the real OPC of each sector that is used for recording in the optical disc recording apparatus according to the embodiment of the present invention.

FIG. 10 is a graph showing correlation between the β value and the recording power that is obtained by the real OPC of the optical disc recording apparatus according to the embodiment of the present invention.

FIG. 11 is a graph showing correlation between the β value and the recording power that is obtained by the real OPC of the optical disc recording apparatus according to the embodiment of the present invention.

### DETAILED DESCRIPTION OF THE PREFERRED EMBODIMENTS

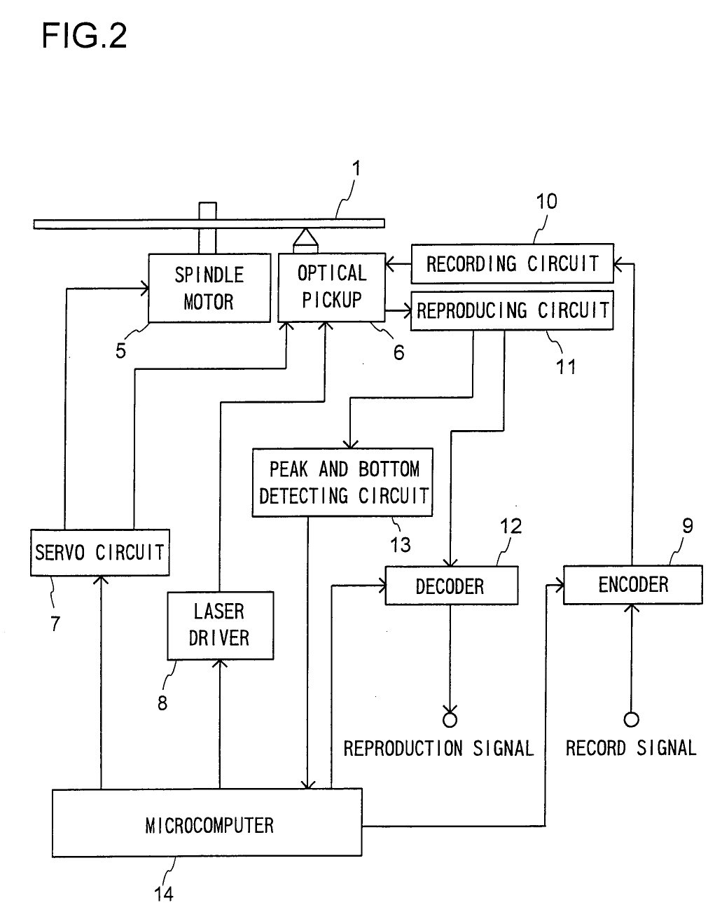

Hereinafter, an embodiment of the present invention will be described with reference to FIGS. 2-11.

First, with reference to FIG. 2, a general outline of a structure of an optical disc recording apparatus according to the embodiment of the present invention will be described. FIG. 2 is a block diagram showing a structure of the optical disc recording apparatus according to the embodiment of the present invention.

As shown in FIG. 2, the optical disc recording apparatus according to the embodiment of the present invention includes a spindle motor 5 that rotates an optical disc 1, an optical pickup 6 that moves linearly for performing recording operation and reading operation on the optical disc 1 by using a laser, a servo circuit 7 that controls rotation speed of the spindle motor 5 and movement of the optical pickup 6 so as to control writing position and reading position on the optical disc 1, a laser driver 8 that controls laser output of the optical pickup 6, an encoder 9 that converts an input record signal, a recording circuit 10 that controls the optical pickup 6 based on the converted record signal, a reproducing circuit 11 that shapes a signal read by the optical pickup 6, a decoder 12 that converts a signal obtained by the reproducing circuit 11 into a reproduction signal, a peak and bottom detecting circuit 13 that detects a peak value and a bottom value of a signal obtained from the reproducing circuit 11, a microcomputer 14 that controls the servo circuit 7, the laser driver 8, the encoder 9 and the decoder 12 so as to control recording and reproducing operations and sets a recording power based on information supplied from the peak and bottom detecting circuit 13.

When recording is performed, a record signal is supplied to the encoder 9, and the signal is supplied to recording circuit 10 after converted by the encoder 9. Then, recording is performed on the optical disc 1 based on the signal delivered from the recording circuit 10 to the optical pickup 6. On this occasion, the servo circuit 7 controls rotation of the optical disc 1 and a position of the optical pickup 6, so that the position on the optical disc 1 where the data is recorded is controlled. In addition, the laser driver 8 controls recording power of the optical pickup 6. Note that the recording power is decided in advance by the OPC that is performed in the first stage of the recording operation.

When reproduction is performed, similarly to the recording case, the servo circuit 7 controls the optical pickup 6 so that a position on the optical disc 1 where the reproduction is performed. On this occasion, the laser driver 8 controls a reading power of the optical pickup 6. In addition, the read signal is supplied to the reproducing circuit 11, and its waveform is shaped. Then, the shaped signal is converted by the decoder 12 and delivered as the reproduction signal.

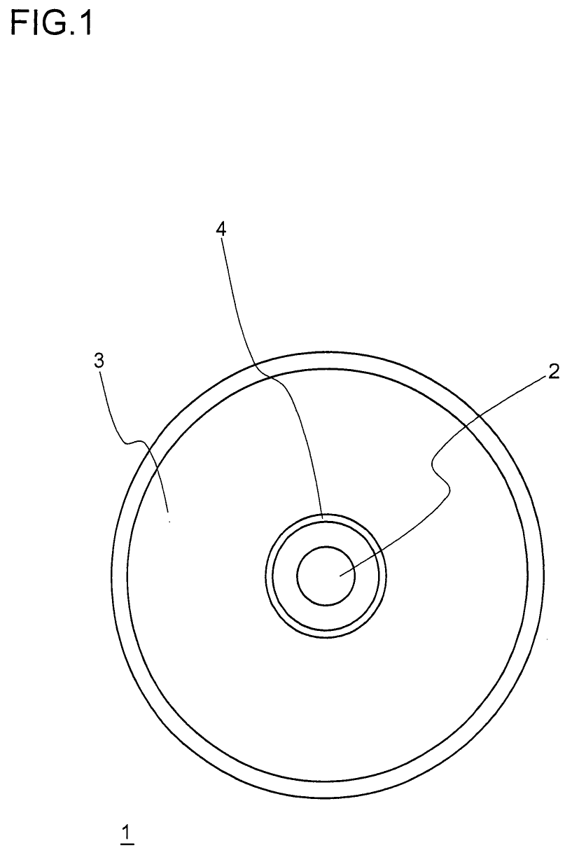

In addition, the OPC that is performed in the first stage of the recording operation performs both the recording process and the reproduction process as described above. First, a plurality of recording steps are performed while changing the recording power in stages with respect to a PCA 4 of the optical disc 1 shown in FIG. 1. Then, the written region is read, and the read signal is supplied to the reproducing circuit 11 shown in FIG. 2. A signal delivered from the reproducing circuit 11 is supplied to the peak and bottom detecting circuit 13, and information of the peak and the bottom of the signal is supplied to the microcomputer 14. Then, the microcomputer 14 calculates a β value based on a value obtained by dividing a difference between amplitude values of the peak and the bottom by a sum of the amplitude values, and it decide the recording power based on this β value.

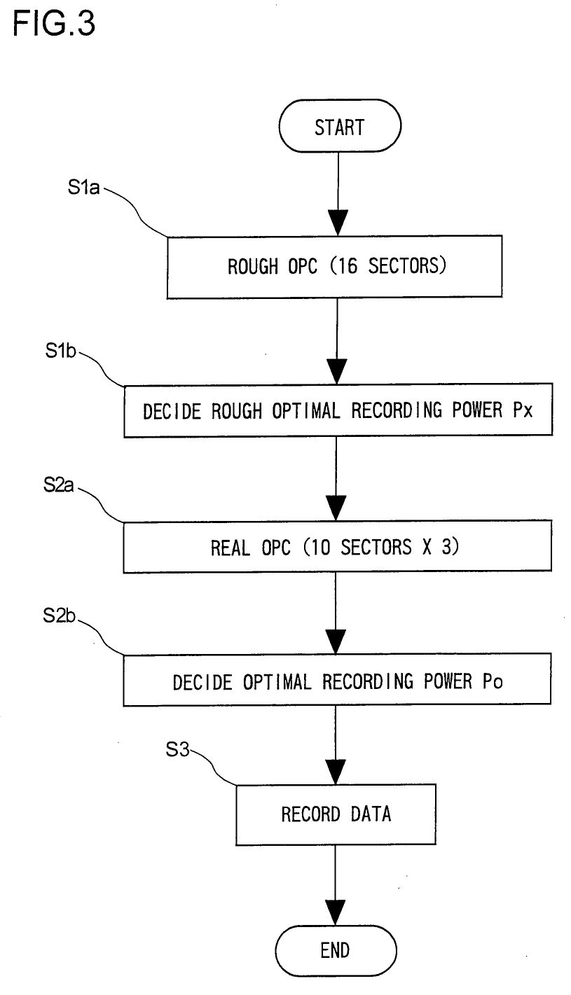

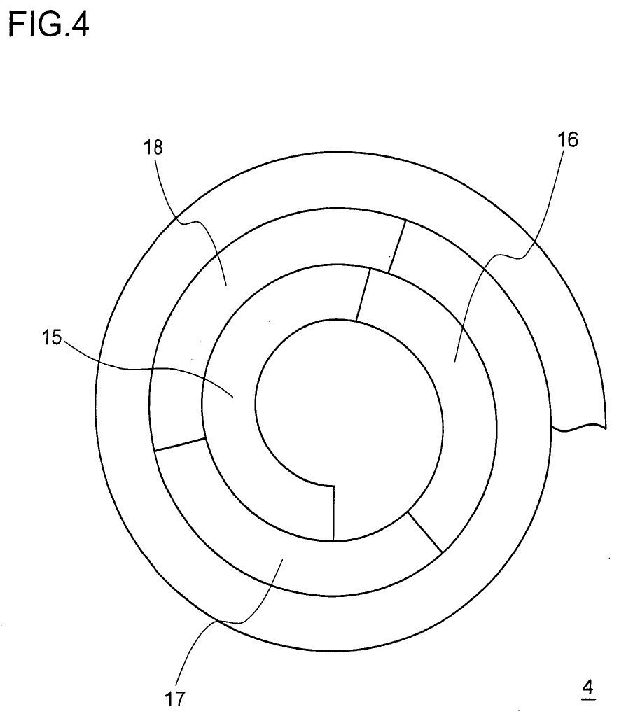

Next, a series of recording operation according to the embodiment of the present invention and the OPC will be described. First, with reference to FIGS. 3 and 4, the recording operation of optical disc recording apparatus according to the embodiment of the present invention and the region of the disc that is used for the OPC will be described. FIG. 3 is a flowchart showing the recording operation of the optical disc recording apparatus according to the embodiment of the present invention, and FIG. 4 is an enlarged schematic diagram of the PCA of the optical disc corresponding to the OPC of the optical disc recording apparatus according to the embodiment of the present invention. Although grooves, wobbles and the like are formed on a usual disc, they are not shown in FIG. 4. Furthermore, FIG. 4 shows an example of a DVD as the disc.

As shown in FIG. 3, the OPC is performed first when the recording operation is started in the embodiment of the present invention. The OPC is divided into two parts including a rough OPC and a real OPC, and the rough OPC is performed first in order to obtain an optimal value of rough recording power (Step S1a). In this case, the region that is used for the rough OPC corresponds to sixteen sectors in the PCA of the disc. If a DVD disc is exemplified, the PCA includes approximately 28 sectors in one circle of the disc. Therefore, as shown in FIG. 4, the rough OPC region 15 on the disc where the rough OPC is performed corresponds to approximately a half circle.

When the rough OPC is finished, a rough optimal recording power Px is decided based on the information obtained by the rough OPC as shown in FIG. 3 (Step S1b). Then, the recording power that is used for the real OPC is decided based on the rough optimal recording power Px. In addition, the recording operation in this real OPC is performed three times by ten sectors each time, so total 30 sectors are used for the recording operation (Step S2a). In this case, three OPCs performed in the real OPC are referred to as a first real OPC, a second real OPC and a third real OPC. In addition, as shown in FIG. 4, the first to the third real OPC regions 16-18 on the optical disc where the first to the third real OPCs are performed are continuous. Therefore, three regions become total 30 sectors, which correspond to approximately one circle of region in the case of a DVD disc. In addition, the rough OPC region 15 and the first to the third real OPC regions 16-18 are continuous. Therefore, the first real OPC region 16, the second real OPC region 17 and the third real OPC region 18 are positioned from the region next to the rough OPC region 15.

Furthermore, as shown in FIG. 3, an optimal recording power Po is obtained from the real OPC (Step S2b), and data recording is performed by this recording power (Step S3).

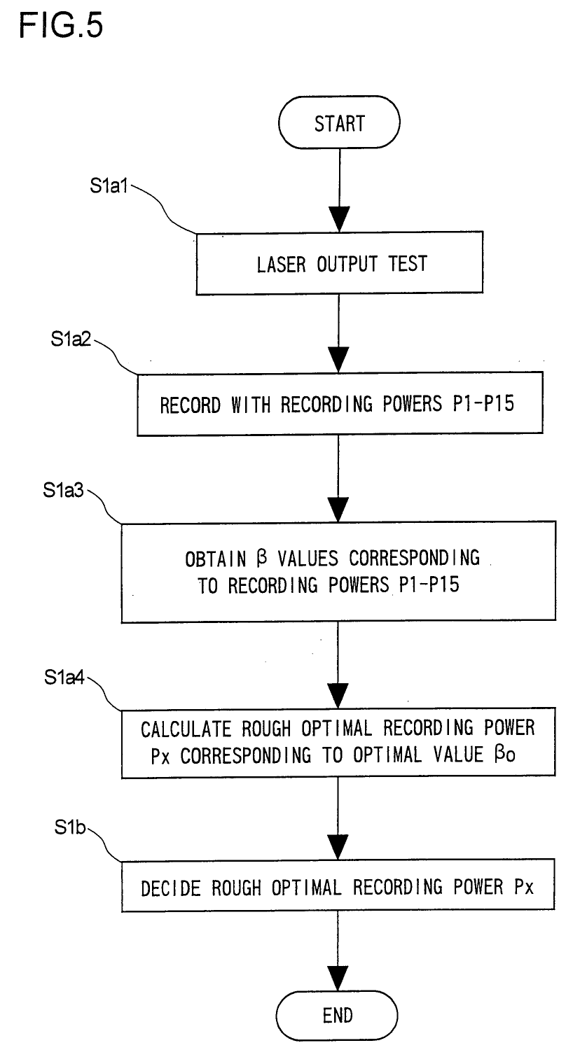

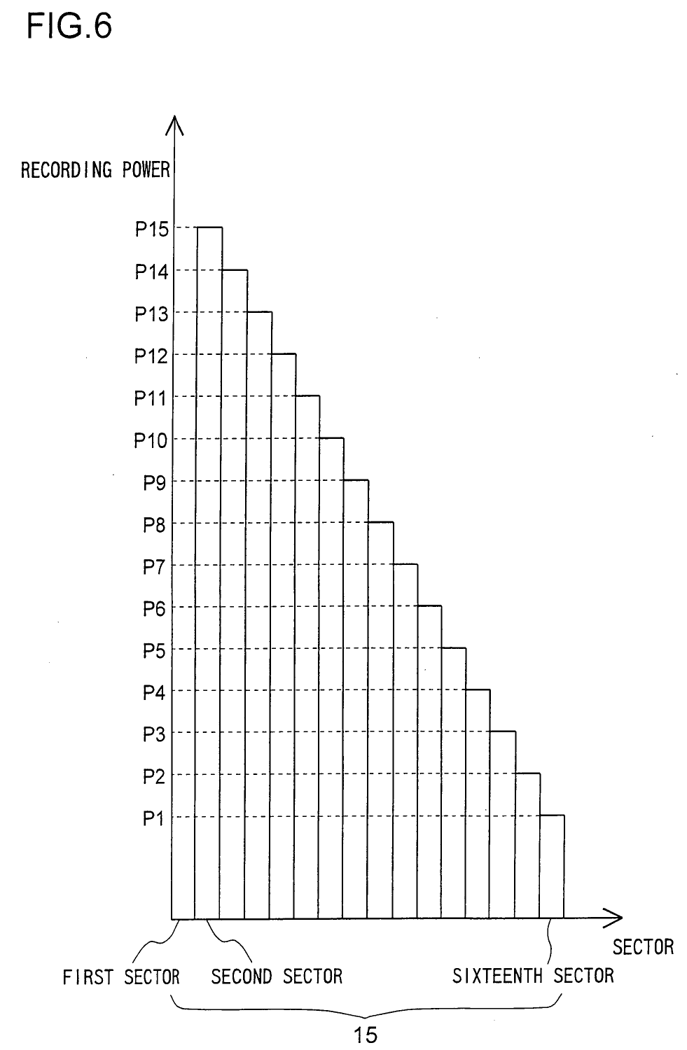

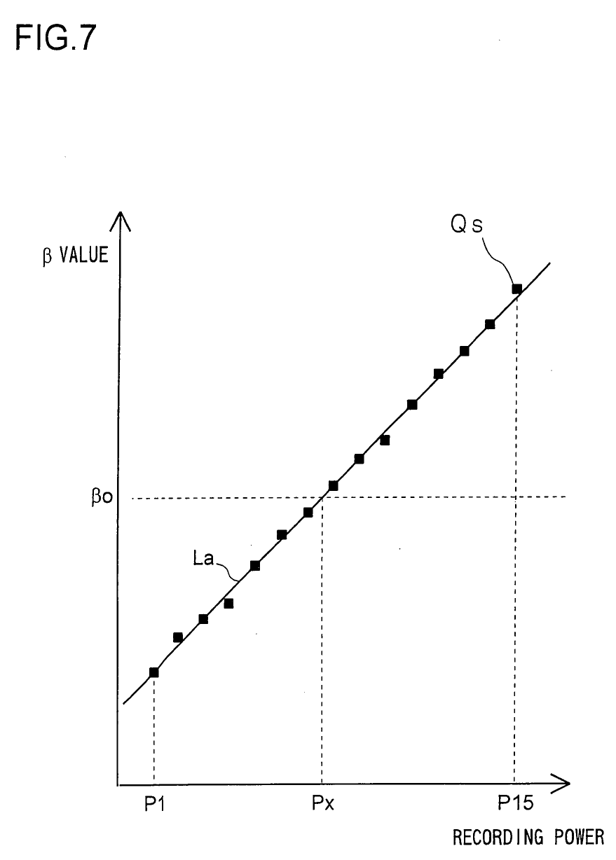

Next, with reference to FIGS. 5, 6 and 7, detail of the rough OPC of the optical disc recording apparatus according to the embodiment of the present invention will be described. FIG. 5 is a flowchart of the rough OPC, and FIG. 6 is a graph showing recording powers for each sector that are used for the rough OPC according to the embodiment of the present invention. In addition, FIG. 7 is a graph showing correlation between the β value and the recording power obtained by the rough OPC of the optical disc recording apparatus according to the embodiment of the present invention.

First, as shown in FIG. 5, a laser output test is performed with respect to the first sector when the rough OPC is started (Step S1a1). Then, by using the 15 stages of recording powers P1-P15 set in advance, the recording operation is performed for each of the 15 sectors from the second sector while changing the recording powers P1-P15 in stages (Step S1a2). More specifically, as shown in FIG. 6, the second sector of the rough OPC region 15 is recorded with the recording power P15, the third to the fifteenth sectors are recorded with the recording powers P14-P2 in this order respectively, and the last fifteenth sector is recorded with the recording power P1. The maximum recording power is P15 while the minimum recording power is P1, and the recording power is adapted to decrease from P15 to P1 in an arithmetic progression.

Next, as shown in FIG. 5, the region of the disc where the recording operation is performed with the recording powers P1-P15 is read out so as to obtain signals corresponding to the recording powers P1-P15 and obtain β values of them (Step S1a3). In this case, if the β values Qs corresponding to individual recording powers P1-P15 are plotted as shown in FIG. 7, an upward-sloping relationship is obtained, in which the β value increases as the recording power increases though it depends on a state of the disc in some degree. Then, correlation between the recording powers P1-P15 and the β values is expressed by an approximate expression La, and the recording power when the β value becomes an optimal value βo in the approximate expression La is regarded as the rough optimal recording power Px.

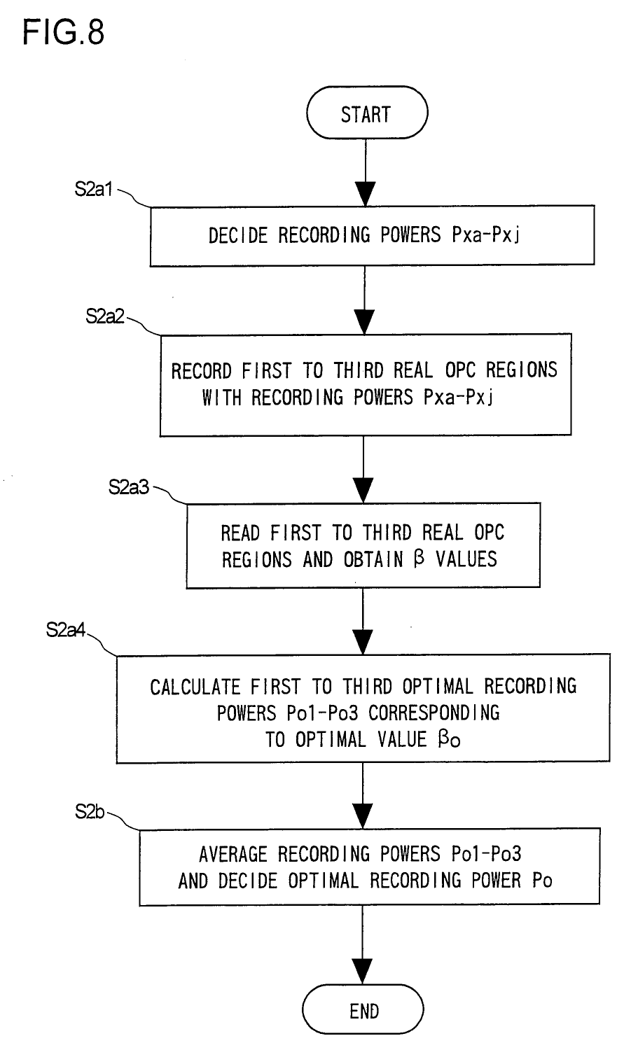

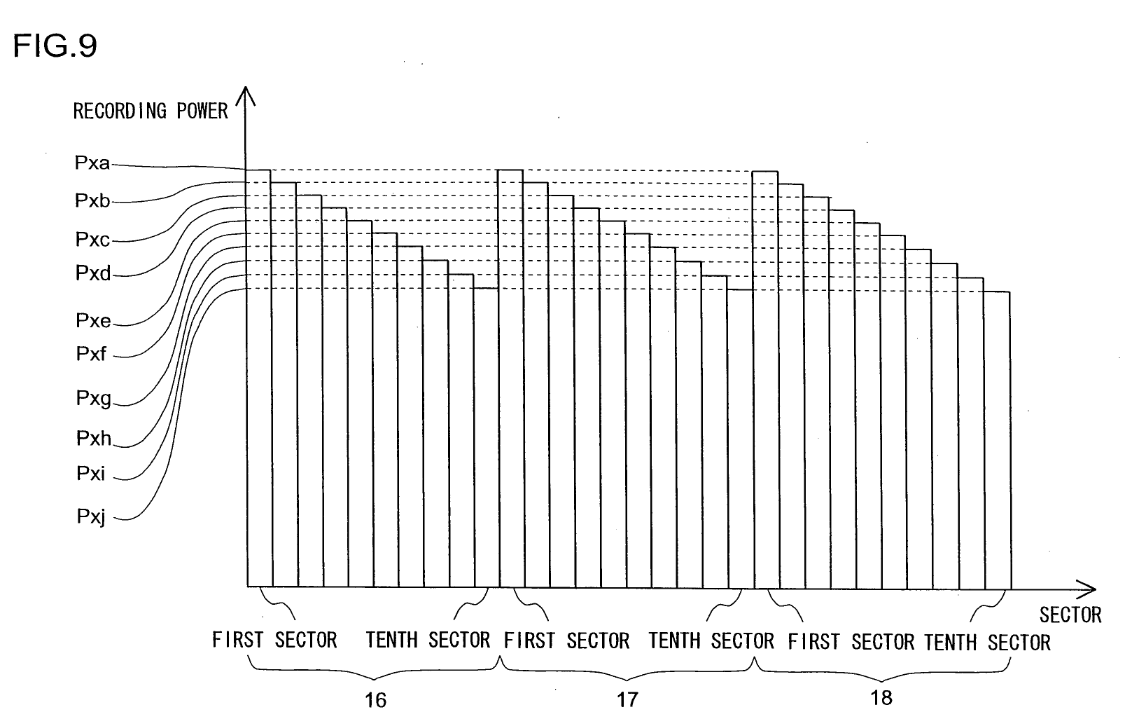

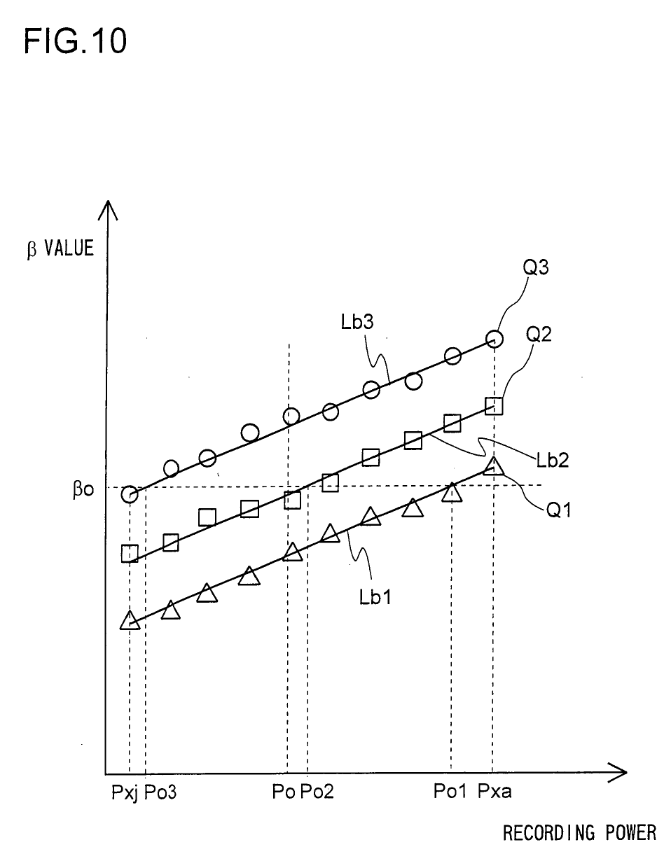

Next, with reference to FIGS. 8, 9 and 10, detail of the real OPC of the optical disc recording apparatus according to the embodiment of the present invention will be described. FIG. 8 is a flowchart of the real OPC of the optical disc recording apparatus according to the embodiment of the present invention, which corresponds to FIG. 5 that shows the rough OPC. FIG. 9 shows recording powers for each sector that are used for the real OPC of the optical disc recording apparatus according to the embodiment of the present invention, which corresponds to FIG. 6 that shows the rough OPC. In addition, FIG. 10 is a graph showing correlation between the β values and the recording powers obtained by the real OPC of the optical disc recording apparatus according to the embodiment of the present invention, which corresponds to FIG. 7 that shows the rough OPC.

First, as shown in FIG. 8, the recording powers Pxa-Pxj that are used for the real OPC are decided when the real OPC is started (Step S2a1). These values are decided based on the values of the rough optimal recording power Px obtained by the rough OPC. For example, a value larger than the rough optimal recording power Px by a predetermined value is regarded as Pxa, while a value smaller than the rough optimal recording power Px by the predetermined value is regarded as Pxj. Then, the range between Pxa and Pxj is divided evenly so that the recording powers are set to decrease from Pxa to Pxj in an arithmetic progression.

Then, the recording operation is performed in each of the first to the third real OPC regions (Step S2a2). On this occasion, as shown in FIG. 9, the recording operation is performed from the first to the tenth sectors of the first real OPC region 16 with the recording powers Pxa-Pxj, respectively. Then, the first to the tenth sectors of the second real OPC region 17 and the third real OPC region 18 are also recorded with the recording powers Pxa-Pxj, respectively and continuously. On this occasion, the recording operation is performed continuously with respect to the first to the third real OPC regions 16-18. In particular, the recording operation is performed continuously for all the three regions while the disc rotates one turn in the case of a DVD disc.

When the recording operation in the first to the third real OPC regions is finished, the reading operation is performed and the β value is obtained as shown in FIG. 8 (Step S2a3). In the case of a DVD disc, all the three regions are performed continuously while the disc rotates one turn similarly to the recording operation of the real OPC.

When the reading operation is performed, a graph showing the correlation between the β value and the recording power obtained by the first to the third real OPCs is obtained as shown in FIG. 10. In this case, points Q1 obtained by the first real OPC are shown by hollow triangles, points Q2 obtained by the second real OPC are shown by hollow squares, and points Q3 obtained by the third real OPC are shown by hollow circles. When the points Q1-Q3 obtained from the first to the third real OPCs are plotted, a substantially upward-sloping relationship is obtained, in which the β value is larger for the larger recording power Pxa while the β value is smaller for the smaller recording power Pxj. Then, similarly to the case of the rough OPC, approximate expressions Lb1-Lb3 are determined with respect to the plots in each region so that the first to the third optimal recording powers Po1-Po3 corresponding to the optimal value βo are determined (Step S2a4). Then, as shown in FIG. 8, the optimal recording power Po is decided by averaging the first to the third optimal recording powers Po1-Po3 (Step S2b).

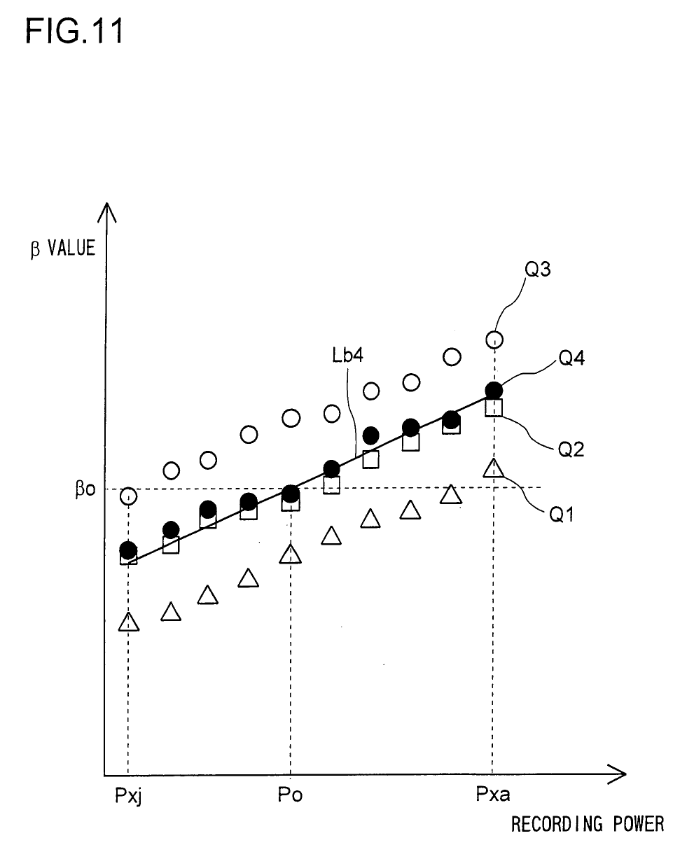

Furthermore, as the method of determining the optimal recording power Po, it is possible to simulate the graph shown in FIG. 11 that shows correlation between the β value and the recording power obtained by the real OPC of the optical disc apparatus according to the embodiment of the present invention. FIG. 11 shows the points Q1-Q3 obtained by the first to the third real OPCs by hollow triangles, hollow squares and hollow circles, respectively, similarly to FIG. 10. It also shows points Q4 by filled-in circles, which indicates average values of β values for each of the recording powers Pxa-Pxj in each region. In this way, it is possible to calculate an average value of β values for the recording powers Pxa-Pxj in advance, and to determine the optimal recording power Po from an approximate expression Lb4 of the plots of the average values. Furthermore, in the case too where the optimal recording power is determined similarly, the recording power corresponding to the optimal value βo in the approximate expression Lb4 is regarded as the optimal recording power Po.

In this way, when the OPC is performed on the optical disc, the optimal recording power is determined from a result obtained by the OPC of total three times and 30 sectors. Therefore, the optimal recording power can be obtained while an influence of a local disturbance is suppressed. Therefore, if this optimal recording power is used, high quality recording operation can be performed.

In addition, the first to the third real OPC regions are continuous regions on the disc, and the recording and the reading operations of the first to the third real OPCs are performed continuously respectively, even if total 30 times of recording and reading operations are performed in the three operations in the real OPC. Therefore, time necessary for the OPC can be reduced. Particularly in the case of a DVD disc, the OPC recording operation can be performed three times during substantially one revolution of the disc, and reading operation can also be performed three times during substantially one revolution of the disc.

In addition, as for an rewritable optical disc such as a CD-RW, a DVD-RW, a DVD+RW and the like, an erasing power may be decided based on the optimal recording power. According to this structure, the erasing power can also be adapted to characteristics of the disc.

In addition, the recording power that is used for the rough OPC may be set to a value in a wide region from nearly the upper limit to nearly the lower limit of the recording power that can be supplied from the optical pickup. Alternatively, it may be set to a value in a predetermined narrow range by estimating the optimal recording power. However, it is preferable to set the recording power in the wide range for determining the recording power of the real OPC.

Although the recording powers P1-P15 and the recording powers Pxa-Pxj that are used for the rough OPC and the real OPC are decreasing as the operation proceeds in FIGS. 6 and 9, it is possible to adopt another structure in which they are increasing as the operation proceeds. For example, the recording operation may be performed in the rough OPC in the second sector with the recording power P1, and the recording operation may be performed in the last fifteenth sector with the recording power P15.

Although the recording apparatus and the recording method of the optical disc according to the embodiment of the present invention is described above, the present invention is not limited to this embodiment, which can be modified variously within the scope of the present invention without deviating from the spirit of the present invention.

The present invention can be used in a recording apparatus and a recording method of an optical disc.

What is claimed is:

1. An optical disc recording apparatus that performs a recording power optimizing operation before recording data on an optical disc, in which data is recorded as a test with a plurality of recording powers having different levels, and an optimal recording power is decided based on a signal read from the data recorded as the test, wherein the data recording as the test in the recording power optimizing operation is performed continuously with respect to three continuous regions on the optical disc, reading of the data recorded as the test is performed continuously with respect to the three continuous regions, and the optimal recording power is decided by averaging three first optimal recording powers obtained from the read signals.

2. The optical disc recording apparatus according to claim 1, wherein the recording powers that are used for the recording power optimizing operation have 10 stages of different levels.

3. The optical disc recording apparatus according to claim 1, wherein a rough recording power optimizing operation is further performed before the recording power optimizing operation, in which data is recorded as a test with a plurality of rough recording powers having different levels, and a rough optimal recording power is decided based on a signal read from the data recorded as the test, and the recording powers that are used for the recording power optimizing operation are decided based on the rough optimal recording power.

4. The optical disc recording apparatus according to claim 3, wherein the rough recording powers that are used for the rough recording power optimizing operation have 15 stages of different levels.

5. The optical disc recording apparatus according to claim 1, wherein an erasing power for erasing data recorded on the optical disc is decided based on the optimal recording power.

6. An optical disc recording apparatus that performs a recording power optimizing operation before recording data on an optical disc, in which data is recorded as a test with a plurality of recording powers having different levels, and an optimal recording power is decided based on a signal read from the data recorded as the test, wherein the data recording as the test in the recording power optimizing operation is performed continuously with respect to three continuous regions on the optical disc, and reading of the data recorded as the test is performed continuously with respect to the three continuous regions, and the optimal recording power is decided based on a signal obtained by averaging read signals.

7. The optical disc recording apparatus according to claim 6, wherein the recording powers that are used for the recording power optimizing operation have 10 stages of different levels.

8. The optical disc recording apparatus according to claim 6, wherein a rough recording power optimizing operation is further performed before the recording power optimizing operation, in which data is recorded as a test with a plurality of rough recording powers having different levels, and a rough optimal recording power is decided based on a signal read from the data recorded as the test, and the recording powers that are used for the recording power optimizing operation are decided based on the rough optimal recording power.

9. The optical disc recording apparatus according to claim 8, wherein the rough recording powers that are used for the rough recording power optimizing operation have 15 stages of different levels.

10. The optical disc recording apparatus according to claim 6, wherein an erasing power for erasing data recorded on the optical disc is decided based on the optimal recording power.

11. An optical disc recording method for performing a recording power optimizing operation before recording data on an optical disc, the method comprising the steps of:
recording data as a test with a plurality of recording powers having different levels; and
deciding an optimal recording power based on a signal read from the data recorded as the test, wherein the data recording as the test in the recording power optimizing operation is performed continuously with respect to three continuous regions on the optical disc, reading of the data recorded as the test is performed continuously with respect to the three continuous regions, and the optimal recording power is decided by averaging three first optimal recording powers obtained from the read signals.

12. An optical disc recording method for performing a recording power optimizing operation before recording data on an optical disc, the method comprising the steps of:
recording data as a test with a plurality of recording powers having different levels; and
deciding an optimal recording power based on a signal read from the data recorded as the test, wherein the data recording as the test in the recording power optimizing operation is performed continuously with respect to three continuous regions on the optical disc, reading of the data recorded as the test is performed continuously with respect to the three continuous regions, and the optimal recording power is decided based on a signal obtained by averaging read signals.

13. An optical disc recording apparatus that performs a recording power optimizing operation before recording data on an optical disc, in which data is recorded as a test with a plurality of recording powers having different levels, and an optimal recording power is decided based on a signal read from the data recorded as the test, and performs a rough recording power optimizing operation before the recording power optimizing operation, in which data is recorded as a test with 15 stages of rough recording powers having different levels, and a rough optimal recording power is decided based on a signal read from the data recorded as the test, wherein the recording powers that are used for the recording power optimizing operation are decided based on the rough optimal recording power, in the recording power optimizing operation, the data recording as the test is performed continuously with respect to three continuous regions on the optical disc with 10 stages of recording powers having different levels, reading of the data recorded as the test is performed continuously with respect to the three continuous regions, the optimal recording power is decided by averaging three first optimal recording powers obtained from the read signals, and an erasing power for erasing data recorded on the optical disc is decided based on the optimal recording power.

14. An optical disc recording apparatus that performs a recording power optimizing operation before recording data on an optical disc, in which data is recorded as a test with a plurality of recording powers having different levels, and an optimal recording power is decided based on a signal read from the data recorded as the test, and performs a rough recording power optimizing operation before the recording power optimizing operation, in which data is recorded as a test with 15 stages of rough recording powers having different levels, and a rough optimal recording power is decided based on a signal read from the data recorded as the test, wherein the recording powers that are used for the recording power optimizing operation are decided based on the rough optimal recording power, in the recording power optimizing operation, the data recording as the test is performed continuously with respect to three continuous regions on the optical disc with 10 stages of recording powers having different levels, reading of the data recorded as the test is performed continuously with respect to the three continuous regions, the optimal recording power is decided based on a signal obtained by averaging read signals, and an erasing power for erasing data recorded on the optical disc is decided based on the optimal recording power.
